(19) United States
(12) Patent Application Publication
(10) Pub. No.: US 2017/0252772 A1
(43) Pub. Date: Sep. 7, 2017

(54) Temperature Manipulated Viscosity Control Module

(71) Applicants: Michael R. Bonner, Romeo, MI (US); C. Robert Gladstone, Romeo, MI (US)

(72) Inventors: Michael R. Bonner, Romeo, MI (US); C. Robert Gladstone, Romeo, MI (US)

(21) Appl. No.: 15/451,874

(22) Filed: Mar. 7, 2017

Related U.S. Application Data
(60) Provisional application No. 62/304,668, filed on Mar. 7, 2016.

(51) Int. Cl. B05C 11/10

(52) U.S. Cl. CPC B05C 11/1007

(57) ABSTRACT

A temperature manipulated viscosity control module for stabilizing fluid viscosity in dispensing applications at (or near) the point-of-application. Connected to a central heating/cooling supply unit, the module both senses temperature and viscosity (and, in the case of waterborne materials, pH as well) and regulates the viscosity of the fluid being dispensed by manipulating the temperature of that fluid. This configuration is a combination of technologies applied together to maintain consistent temperature of the fluid and the sensors to assure that process conditions are consistent for measurement, control, and application.

The application claims priority to U.S. Ser. No. 62/304,668 filed Mar. 7, 2016, the specification of which is incorporated by reference in its entirety herein. This disclosure relates to systems that dispense material and regulate characteristics of the dispensed material upon application.

### BACKGROUND

Modern manufacturing and assembly processes often include fluid dispensing and/or application operations. Fluid dispensing processes can include, but need not be limited to, operations such as printing, coating, painting, adhesive application, sealing and lubrication and the like. In these fluid dispensing and/or application operations, the quality of the dispensing process is dependent on many factors including the viscosity of the fluid material being dispensed. For example, in printing operations, ink viscosity is directly related to accuracy of the image with regards to color and dot placement, as well as size and shape. In coating and painting applications, the thickness of the applied film, and the surface finish of that film, are both dependent on the viscosity and rheology of the fluid material at the time of application. In gluing or sealing applications, the volume of material dispensed, the profile of the applied bead of material, the material placement, and retention of that placement are all dependent on the viscosity of the sealer/adhesive material being applied.

It is desirable to measure and adjust the viscosity of fluid material being dispensed as a part of the process control function associated with a given manufacturing process. In certain situations, the desired dispense viscosity is lower than that of the virgin material supplied by the formulator. Viscosity adjustment is accomplished by first measuring the viscosity of the material with an efflux cup, then adding an appropriate solvent to reduce the material viscosity to the desired application viscosity. If too much solvent is added and the viscosity of the material is over-adjusted, virgin material can be added to raise the viscosity back to the value desired for dispense. This type of viscosity adjustment is generally performed at the point of supply—usually in a bulk container—as this is the most convenient location to access the fluid material to be dispensed.

It has been proposed that fluid viscosity measurement and control of fluid material being dispensed occur at the point of application or as near as possible to that point. In various situations, it has been found that viscosity characteristics of a fluid material being dispensed can be directly dependent on the temperature at which it is being dispensed. Thus, as it is difficult, if not impossible to add solvent or virgin material effectively at the point of fluid material application, the ability to vary temperature to control viscosity of the fluid material becomes more desirable and the ability to accurately ascertain fluid material viscosity and to effectively control the viscosity of the fluid material at the point of application is desirable. Thus it is desirable to provide a device and method that can vary temperature at the point of application to control fluid material viscosity on application. It is also desirable to provide an application method and device that can accurately assess fluid temperature upon viscosity measurement and the temperature at which the fluid is applied. Furthermore, it is desirable to provide an application method and device that will minimize erroneous application results and negative application effects.

### SUMMARY

A fluid control module that includes at least one process material conveying tube having an inlet end and an outlet end, an outwardly oriented surface and an inner channel. The process material tube has at least one spiral region. The fluid control module also has at least one outer shell that is coaxially disposed around the at least one process material conveying tube and is positioned a spaced distance therefrom. The at least one outer shell has an inlet end and an outlet end and an inwardly oriented surface, wherein the inwardly oriented surface of the outer shell and the outwardly oriented surface of the process conveying tube define a thermal conditioning material conveying channel. The fluid control module also includes at least one viscosity sensor that is in fluid communication with the inner channel of the process material conveying tube. The viscosity sensor is configured to generate data signals and is positioned in a region in the process material conveying tube that is defined by the coil region.

These and other aspects of the present disclosure are disclosed in the following detailed description of the embodiments, the appended claims and the accompanying figures.

### BRIEF DESCRIPTION OF THE DRAWING

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIG. 1 is an orthogonal view of a temperature manipulated viscosity control module according to an embodiment as disclosed herein;

FIG. 2 is a perspective view of an embodiment of the exterior housing of an embodiment of the temperature manipulated viscosity control module of FIG. 1 as disclosed herein;

FIG. 3 is a cross section of an embodiment of the heat exchange tube as employed in the temperature manipulated viscosity control module of FIG. 1;

FIG. 4 is an orthographic view of an embodiment of a block assembly that can be used in association with an embodiment of the temperature manipulated viscosity control module of FIG. 1;

FIG. 5 is a cut-away view of the block assembly of FIG. 4; and

FIG. 6 is an orthographic view of an embodiment of the hose assembly disclosed herein having an embodiment of the block assembly disclosed herein.

### DETAILED DESCRIPTION

The temperature manipulated viscosity control module as disclosed herein combines the measurement and control functions for dispensing fluids into a small, self-contained insulated package that can be mounted at or very near the point-of-fluid material application. The focus of this control is on the viscosity of the process fluid material that is being dispensed, though this embodiment can also include configurations that permit the option to measure and report other material-relevant parameters including, but not limited to pH as for those aqueous (water-based) fluids where pH is an important parameter. It is contemplated that the device as disclosed, by combining measurement and control functions into a single enclosure provides a configuration whereby the respective sensors can be maintained at the same temperature as the process fluid material being dispensed. This assures that optimal application viscosity for the given process fluid material and the associated application process can be maintained at all times. Because these measurement and control functions can now be located immediately prior to the point of application of the process fluid material and can be performed in real time, the control of the process fluid material application process is proactive instead of reactive.

The temperature manipulated viscosity control module 10 as disclosed herein may include a housing 12 that defines an interior chamber 13. The housing 12 can be configured to produce a thermal environment that isolates the interior chamber 13 defined in the housing 12 from the surrounding ambient environment during operation of the temperature manipulated viscosity control module 10. The housing 12 may be composed of steel, plastic, engineering composites, or other suitable material that can provide structural support for the housing 12.

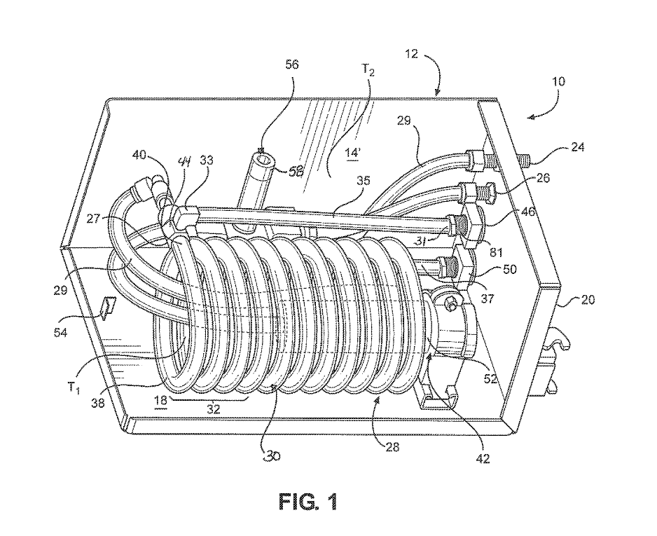

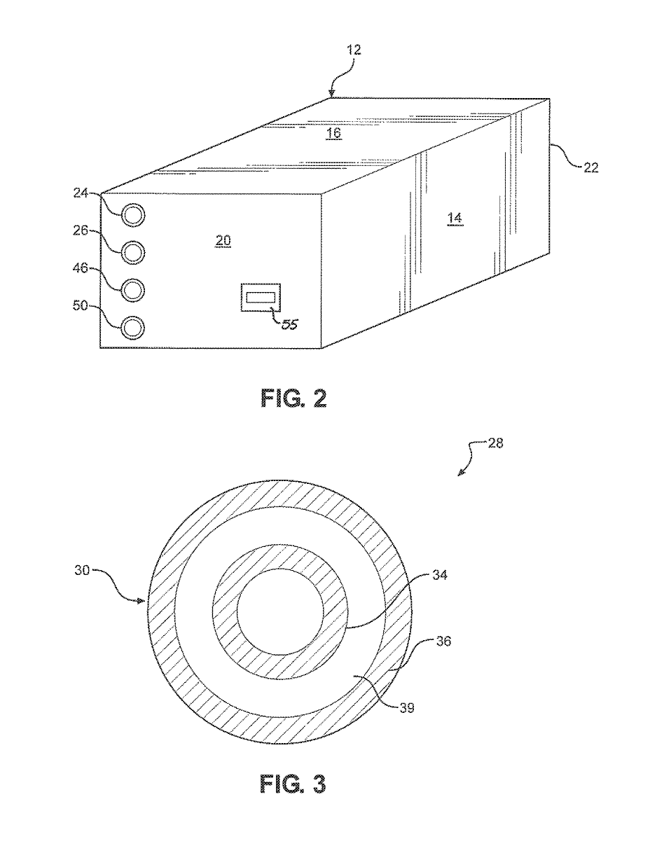

The housing 12 can have any suitable configuration. In the embodiment depicted in FIGS. 1 and 2, the housing 12 is rectilinear and includes opposed lateral side wall panels 14 and 14′, as well as top wall panel 16 contiguously attached to and spanning the distance between the two opposed lateral side wall panels 14,14′. The housing 12 also includes a bottom support wall panel 18 that is contiguously connected to the lateral side wall panels 14 and 14′ at a location that is spaced from the top wall panel 16. The housing 12 may also include a forward end wall panel 20 and opposed rearward end wall panel 22 that are connected to the later side wall panels 14, 14′ as well as a top wall panel 16 and bottom support wall panel 18. In certain embodiments such as that depicted in FIGS. 1 and 2, top wall panel 16 and bottom support wall panel 18 are disposed parallel to one another. In certain embodiments, the forward end wall panel 20 and rearward end wall panel 22 are oriented parallel to one another. Each of the various wall panels has an outwardly oriented surface and an inwardly oriented surface. The housing 12 can be constructed such that one or more of the various wall panels is constructed as individual units or can be formed from an individual sheet and bent to form the housing 12.

The housing 12 can have insulating characteristics. It is also contemplated that the one or more of the wall panels 14, 14′, 16, 18, 20, 22 be composed of materials with inherent insulating characteristics. It is also contemplated that one or more of the wall panels 14, 14′, 16, 18, 20, 22 can include at least one insulation layer (not shown). The insulation layer can be configured on either the outwardly oriented surface of the respective wall panel, the inwardly oriented surface or any combination of the forgoing. It is also contemplated that the insulation layer can be present on both faces of a respective wall panel as desired or required. In certain embodiments, the insulation layer may be formed from a solid type spray-coating overlying the exterior of the housing 12, or it may be composed of an open or closed cell foam type material applied to the inside of the housing 12, or of a sheet-formed type, cut to size and affixed with adhesive to the inside of the housing 12. In certain configurations, the housing 12 has a hard exterior that is impervious or at least resistant to the fluid(s) being dispensed and that can be wiped down for the cleaning purposes to remove any fluid that may have ended up on the exterior of the housing 12. The housing 12 can be configured with a suitable reclosable opening or access portal in order to access devices housed in the interior chamber 13 for routine maintenance service or the like as desired or required.

The housing 12 is configured with at least one process fluid material inlet 24 that is defined in one of the wall panels 14, 14′, 16, 18, 20, 22. In the embodiment illustrated in FIGS. 1 and 2, the at least one process fluid material inlet 24 is defined in the forward end wall panel 20. The at least one process fluid material inlet 24 can be configured with suitable connectors to facilitate fluid connection between an external process fluid material source (not shown) and the temperature manipulated viscosity control module 10. In certain embodiments this is accomplished by connection between the external process fluid material transfer member and the at least one process fluid material inlet 24 as by a suitable process fluid material transfer hose (not shown) that is associated with the external fluid material transfer system. Where desired or required, the connection can be facilitated by mating quick connect fittings.

In the configuration as depicted in the drawing figures, the process fluid material to be dispensed and applied enters the temperature manipulated viscosity control module 10 through the process fluid material inlet 24, where it is routed into the processing inlet 27 of a hard core coil recorable coaxial heat exchanger 28 that is contained in the interior chamber 13 of housing 12. Where desired or required, the hard core recorable heat exchanger 28 can include suitable straps or anchors (not shown) to mount the hard core recorable heat exchanger 28 to the housing 12 as by connection to the bottom support panel 18. The processing inlet 27 can be in direct fluid connection with the process fluid material inlet 24 in certain embodiments. It is also contemplated that suitable devices and intermediate units can be interposed between the process fluid material inlet 24 and the processing inlet 27 of the hard-core coil recorable coaxial heat exchanger 28 as desired or required.

In the operating condition, the processing inlet of the 27 of the hard core recorable coaxial heat exchanger 28 is in fluid communication with the process fluid material inlet 24. In the embodiment depicted, fluid communication is accomplished by a suitable internal conveyance conduit 29 that can extend between the process fluid material inlet 24 and the processing inlet 27 in a fluid tight manner.

In certain embodiments, such as the embodiment depicted in FIG. 3, the hard core coil recorable coaxial heat exchanger 28 can have a tube-in-tube configuration. In the embodiment depicted in FIG. 3, a process fluid material conveying tube 34 is surrounded by an outer tube shell 36 that defines a thermal conditioning fluid conveying channel 39 that can be disposed around the process fluid material conveying tube 34. In the embodiment depicted, the outer tube shell 36 can be disposed around the process fluid material conveying tube 34 in a coaxial manner. It is also within the purview of this disclosure that other embodiments can include positioning thermal conditioning fluid conduit interior to a process fluid material channel if desire.

The hard core recorable coaxial heat exchanger 28 can be a configured as a continuous tube structure 30. Where desired or required, the process fluid material conveying tube 34 of the continuous tube structure 30 can be formed of a suitable heat transfer material that is compatible with the respective process fluid material(s) passing there through. In certain embodiments, the process fluid material conveying tube 34 of the continuous tube structure 30 can be constructed, in part or in whole, from mild or stainless steel, or other material(s) that has suitable thermal transfer characteristics. In certain embodiments, the outer tube shell 36 can be composed in whole or in part of a material that will permit conveyance of the desired thermal conditioning fluid there through and facilitate heat transfer between the thermal conditioning fluid and process fluid material transiting the process fluid material conveying tube 34. In certain embodiments, the outer tube shell 36 can be composed of suitable polymeric material.

The continuous tube structure 30 can have a suitable length and configuration to provide thermal conditioning of the process fluid material passing there through. The process fluid material conveying tube 34 can have a suitable diameter to provide for delivery of a suitable volume of material processing the desired characteristics such as viscosity and the like.

In certain configurations, at least a portion of the continuous tube 30 structure is configured as a coil region such as coil region 32. The coil region 32 is defined as a region in which at least one first defined segment of the continuous tube structure 30 is placed proximate to at least one second defined segment of the continuous tube structure 30 that is discrete from the first defined segment.

In certain embodiments, the coil region 32 defines an interior central region. In the embodiment illustrated, the coil region 32 is configured as a spiral that can include at least two turns or coil members 38. The coil region 32 can include any number of turns or coil members 38 and can include between five and twenty turns or coil members 38 in certain configurations. In certain embodiments, the coil region can have between five and ten turns or coil members 38.

The turns or coil members 38 of the coil region 32 are in spaced relation to one another and are spaced apart from one another at a distance sufficient to permit the process fluid material conveying tube 34 in the coil region 32 to be surrounded with the material that forms the outer tube shell 36 of the hard core recorable coaxial heat exchanger 28. In certain use conditions, the outer tube shell 36 can have an outer shell diameter such that the individual turns or coil members 38 are in spaced non-touching relation to one another. Where desired or required, two or more of the turns or coil members 38 can be positioned such that the outer surface the respective outer shell tubes 36 contact one another. While the turns or coil members 38 can have any suitable configuration that defines an interior space in the resulting continuous tube structure 30, in certain embodiments, the turns or continuous coil members 38 will have a spiral or spirorbid configuration and can have a pitch between 5 and 20 degrees relative the cross section of the continuous tube structure 30.

The continuous tube structure 30 has an inlet end 40 and an opposed outlet end 42. The inlet end 40 and outlet end 42 of the continuous tube structure 30 are configured with suitable block assembly connector devices 44 that facilitate and direct introduction and egress of process fluid material into and away from the process fluid material conveying tube 34 while sealing the connection from leakage into the interior chamber 13 of the housing 12. In the embodiment depicted, the block assembly connector devices 44 are recorable hose connectors that are configured to connect to a suitable end of the process fluid material conveying tube 34 and a suitable end of the outer tube shell 36 to form the thermal conditioning fluid conveying channel 39 between the interior face of the outer tube shell 36 and the exterior surface of the process fluid material conveying tube 34. The configuration and volume of the channel 39 so formed is sufficient to receive and convey a suitable thermal conditioning fluid in a circuit through the resulting space to regulate temperature conditions in the interior of the process fluid material conveying tube 34. In certain embodiments the thermal conditioning fluid conveying channel 39 can be an annular space and the thermal conditioning fluid can be a material that can control the temperature of the associated area. In certain embodiments the and thermal conditioning fluid can be a liquid material. It is contemplated that the thermal conditioning fluid can be an aqueous material such as water or water-based compositions.

The thermal conditioning fluid can be introduced into the housing 12 of temperature manipulated viscosity control module 10 through the thermal control fluid inlet 46 defined in the housing 12. The thermal conditioning fluid inlet 46 can be configured with suitable connectors to establish and maintain fluid connection between an external source of thermal conditioning fluid (not shown) and the thermal conditioning fluid conveying channel 39. The thermal conditioning fluid can be delivered by suitable hoses and the like. Where desired or required, the external source of thermal conditioning fluid can include suitable pumps and regulators to deliver thermal conditioning fluid to the temperature manipulated viscosity control module 10. The external source of thermal conditioning fluid can also include suitable heaters, coolers and the like to alter and/or maintain the temperature of the thermal conditioning fluid at a desired set point. Temperature control of the external source of thermal conditioning fluid can be based, at least in part, on inputs from the temperature manipulated viscosity control module 10.

The thermal conditioning fluid that is introduced into the temperature manipulated viscosity control module 10 through thermal conditioning fluid inlet 46 is introduced in to the thermal conditioning fluid conveying channel 39 defined between the outer tube shell 36 and the process fluid material conveying tube 34. In the embodiment illustrated in FIG. 1, the thermal conditioning fluid is conveyed to the thermal conditioning fluid conveying channel 39 via thermal fluid conveying hose 35. The thermal fluid conveying hose 35 can have a first end 31 in fluid connection with the thermal conditioning fluid inlet 46 and an opposed second end 33 that is in fluid communication with the respective recorable hose block assembly 44.

Thus the recorable hose block 44 is in fluid commination with and conveys both the introduced process fluid material and the introduced thermal conditioning fluid. It is contemplated that suitable devices can be interposed between the thermal conditioning fluid inlet 46 and the hard core recorable coaxial heat exchanger 28 to monitor the condition of thermal conditioning fluid as desired or required and to provide inputs to the external source if required.

The introduced thermal conditioning fluid passes through the thermal conditioning fluid conveying channel 39 to accomplish heat transfer and/or maintain temperature resident in the process fluid material transiting the process fluid material conveying tube 34. The thermal conditioning fluid can be conveyed out of the temperature manipulated viscosity control module 10 through thermal conditioning fluid outlet 50. The thermal conditioning fluid can be conveyed from the hard core recorable coaxial heat exchanger 28 to the thermal conditioning fluid outlet 50 via intermediate process fluid conveying tube 37. The exiting thermal conditioning fluid can be conveyed back to the external thermal conditioning fluid source where it can be subjected to any temperature adjustment based on inputs received from the temperature manipulated viscosity control module 10 and recirculated for future use in the temperature manipulated viscosity control module 10. The thermal conditioning fluid can also be employed f or other suitable applications with or without suitable thermal adjustment as required.

While transiting the thermal conditioning fluid conveying channel 39, the thermal conditioning fluid can modify or maintain the temperature of the fluid process material flowing through the process fluid material conveying tube 34. The process fluid material conveying tube 34 is in fluid communication with process fluid material outlet 26 to permit exit of the conditioned process fluid material from temperature manipulated viscosity control module 10 and application on the desired substrate surface. The outlets of the process fluid material conveying tube 34 and outer tube shell 36 can include a suitable block assembly such as block assembly 44 to facilitate transit of the fluid process material away from hard core recorable coaxial heat exchanger 28.

In the embodiment depicted in FIG. 1, the continuous tube structure 30 portion of the heat exchanger 28 can be replaced at any time—either as a maintenance function or, where desired or required, the continuous tube structure 30 can be comprised of various materials that are selected to ensure compatibility with the process fluid material being dispensed. The continuous tube structure 30 can be changed in the event that a new process fluid material is selected dispensing that is incompatible with one or more materials in the existing continuous tube structure.

It is also contemplated that the diameter and/or wall thickness of the process fluid material conveying tube 34 can be varied to enable the temperature manipulated viscosity control module 10 to be used with systems operating at higher dispense pressures. In certain embodiments, the number of wraps in the coil region 32 can be varied to change the thermal transfer area of the heat exchange (HX) as required for various applications. Thus it is contemplated that a continuous tube structure 30 may include at least two wraps in the coil region 32. In certain applications, continuous tube structure 30 can have a greater number of wraps depending on the amount of thermal conditioning required in a given situation. The ability to remove and replace one continuous tube structure 30 with a tube having different heat exchange characteristics as by having different materials of construction and/or different numbers of coils can facilitate the effectiveness of the associated temperature manipulated viscosity control module 10.

The temperature manipulated viscosity control module 10 can also include at least one viscosity sensor 52. In certain embodiments, the viscosity sensor 52 is positioned to be in fluid contact with the process fluid material passing through the process fluid material conveying tube 34 of the continuous tube structure 30. In the embodiment as illustrated, at least one viscosity sensor 52 is positioned in contact with the process fluid material stream at the outlet end 42 of the continuous tube structure 30. Thus as process fluid material exits the continuous tube structure 30, it can feed directly into a suitable inlet of the viscosity sensor 52. This can occur at a location prior to the process fluid material exiting the housing 12 as through thermal conditioning fluid outlet 50. In the embodiment illustrated in FIG. 1, the viscosity sensor 52 is located between the exit of hard core recorable coaxial heat exchanger 28 and the intermediate process fluid conveying tube 37. In certain embodiments, the viscosity sensor can be positioned in the process stream immediate prior to housing exit.

The temperature manipulated viscosity control module 10 may also include at least one temperature sensor 54 configured to monitor thermal conditions existing in housing 12. Where desired or required, the temperature manipulated viscosity control module 10 can include two or more temperature sensors that are positioned at different locations to monitor thermal conditions within the housing 12. The temperature sensor(s) 54 can be electronically connected to a suitable monitoring system to assess thermal conditions within the interior of the housing 12. The temperature manipulated viscosity control module 10 can include temperature sensors configured to assess the thermal conditions at one or more points in either process fluid material stream or the thermal conditioning fluid stream or both. Temperature assessment can be by direct measurement where desired or required.

Data derived from the housing temperature sensor(s) 54, the instream temperature sensors and/or viscosity sensor(s) 52 can be relayed to suitable processors that can be located external to the temperature manipulated viscosity control module 10 where the generated data can be analyzed to derive and determine any condition setting changes needed to control viscosity of the process fluid material. Where desired or required, the viscosity sensor(s) 52 can be equipped with a suitable temperature sensor to provide contemporaneous assessment of temperature and viscosity.

Non-limiting examples of suitable temperature sensors include various RIDs, thermocouples, thermistors, etc. In the temperature manipulated viscosity control module 10 as shown, a temperature signal can be sent to an external control circuit (not shown) via a suitable sensor connector couple 55 for monitoring purposes and/or for adjusting the temperature of the thermal conditioning fluid prior to entry into the hard core recorable coaxial heat exchanger 28. It is also contemplated that the temperature of the thermal conditioning fluid can be modified as it enters and/or exits the housing 12 as at thermal conditioning fluid inlet and/or thermal conditioning fluid outlet with temperature adjustment occurring upon notification that the process fluid material to be dispensed is not at the desired set point temperature.

In certain embodiments, the viscosity sensor 52 shown in the embodiment pictured in FIG. 1 can be one that is classified as a “no-moving-parts” type viscometer. Such viscometers can have a generally cylindrical shape that permits the viscometer to be inserted into the central region defined by the coil members 38 of the continuous tube structure 30. The viscosity sensor 52 can be constructed of any suitable material. In certain embodiments, the viscosity sensor 52 can be made of a suitable thermally conductive material such as steel.

Without being bound to any theory, it is believed that the transit of thermal conditioning fluid through the thermal conditioning fluid conveying channel 39 as it passes through the helically oriented coil members 38 generates a controlled thermal region T₁ that is located within the interior of the region defined by coil members 38. The orientation of the viscosity sensor 52 in controlled thermal region T₁ provides a thermal control environment for the viscosity sensor 52 to maintain the body of the viscosity sensor 52 at the controlled process temperature. When so configured, the body of the viscosity sensor 52 conducts the temperature of continuous tube structure 30 and associated thermal conditioning fluid and, due to its thermal mass, the viscosity sensor 52 combines with the process fluid material flow through the interior of the viscosity sensor 52, to become part of the temperature control circuit. At the same time, the temperature of the viscosity sensor 52 is stabilized at the set point temperature of the process fluid material being dispensed to assure that all measurements are taken at a consistent temperature. Though the shape of this viscosity sensor 52 can be cylindrical for added effectiveness of the system, any viscometer having any suitable geometry can be used in the temperature manipulated viscosity control module 10 disclosed.

The temperature manipulated viscosity control module 10 can also include various other sensors and monitoring devices as desired or required. In the embodiment as depicted in FIG. 1, the temperature manipulated viscosity control module 10 includes at least one pH sensor 56 in fluid contact with the process fluid material stream. In certain applications as where the process fluid material stream is an aqueous or water borne material, the pH sensor can be positioned downstream of the viscosity sensor 52. It has been discovered, quite unexpectedly, that positioning the pH sensor 56 in this manner in the temperature manipulated viscosity control module 10 as disclosed can ensure reliable and repeatable pH measurements, independent of changes in ambient temperature. These pH measurements can be fed to an associated external control circuit (not shown) via the sensor connector couple 58. In embodiments in which no pH sensor 56 is included, the process fluid material can be routed directly from the outlet of the viscosity sensor 52 to the process fluid material outlet 26.

Though the embodiment demonstrated in FIG. 1 shows the dispensed fluid process material path interconnected with low-pressure tubing and quick-disconnects, such as might be used in an ink dispensing application found in a flexographic or gravure printing system, these interconnections can be accomplished with braided-reinforced hoses or solid tubing and flare fittings to enable operation at higher pressures where desired or required.

The helically shaped hard core recorable coaxial heat exchanger 28 also produces a localized thermal control region T₂. The localized thermal control region T₂ is the area in the interior chamber of housing 12 exterior of the helical coil region T₁. Without being bound to any theory, it is believed that the ambient temperature of region T₂ will be equal or substantially equal to the temperature of region T₁. It is believed that thermal conditioning fluid passing through thermal conditioning fluid conveying channel 39 will control ambient temperature of the interior of housing 12. Changes in measured viscosity outside predetermined set points can trigger signals and action that result in alteration in the temperature of the thermal conditioning fluid transiting the thermal conditioning fluid conveying channel 39 defined in the hard core recorable coaxial heat exchanger 28. The temperature alterations can result in changes in the temperature in one of both of regions T₁ and T₂. Thus equilibrium between the thermal conditioning fluid temperature and the interior temperature in the housing 12 can be reached and maintained. It is contemplated that the thermal conditioning fluid can be employed to establish an equilibrium temperature in the interior of the housing 12 and thereby condition the temperatures of the viscosity sensor 52 as well as any other measurement devices present in the temperature manipulated viscosity control module 10.

The temperature manipulated viscosity control module 10 can be attached to any suitable material application device, at a location that is proximate to or immediately prior to the point of exit for the process fluid material that is being applied. It is contemplated that the application device can be a robotic arm, in which case the temperature manipulated viscosity control module 10 could be affixed on the moveable arm member at a location proximate to the applicator opening. In printing or inking operations, the temperature manipulated viscosity control module 10 can be located proximate to one or more suitable roller applicators or the like. It is also contemplated that a given application device such as a printing or inking machine can include multiple dedicated temperature manipulated viscosity control modules 10 based on the performance characteristics of the various materials to be applied.

Where desired or required, the hard core recorable coaxial heat exchanger 28 can be accessed by a suitable access port (not shown) defined in one or more housing panel members. The block assembly(ies) 44 facilitate the rapid removal and exchange of hard core recorable coaxial heat exchanger 28 for new or different units. Exchange can be for purposes of routine maintenance. It is also contemplated that the hard core recorable coaxial heat exchanger 28 can be substituted based on changes in process fluid composition and the like.

As previously discussed, the hard core recorable coaxial heat exchanger 28 can include at least one suitably configured block assembly 44 that can be positioned at either the first end 21 or the second end 23 of the continuous tube 30. Where desired or required, the continuous tube 30 can include block assemblies at both the first end and the second end.

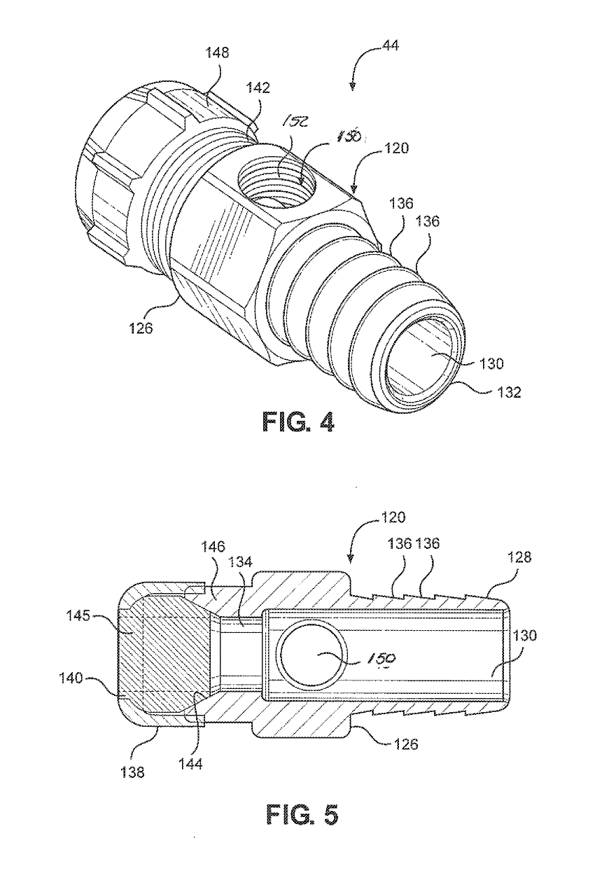

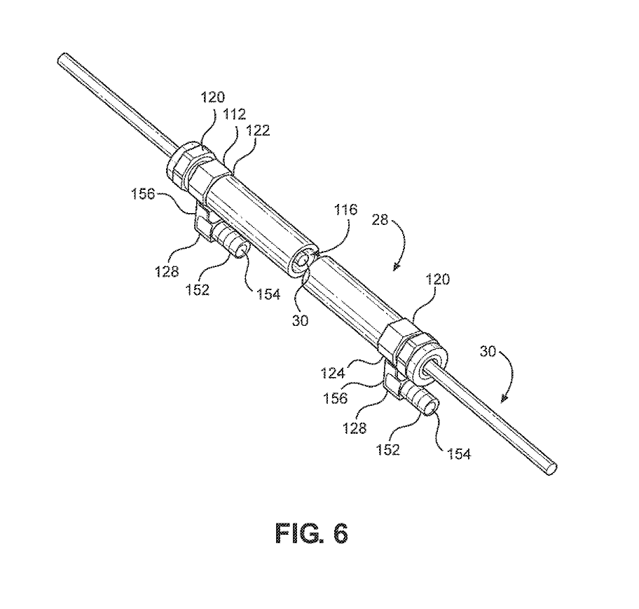

An embodiment of the block assembly 44 is depicted orthographically in FIG. 4 and in cross sectional view in FIG. 5. The block assembly 44 can be machined, molded or otherwise formed from a suitable material. The material of choice can be a material exhibiting characteristics in which the block assembly 44 is thermally compatible with the surrounding module elements such as the continuous tube 30. By thermally compatible, it is meant that the block assembly 44 will maintain and convey the temperature of the thermal conditioning fluid. As it transits the thermal conditioning fluid conveying channel 39. Non-limiting examples of such materials include various metals such as aluminum, steel, copper, various polymeric materials, ceramic materials and the like. It is contemplated that each block assembly 44 includes a central body portion 126 that can be produced from a single block of material where desired or required. Each block assembly 44 can also include a thermal conditioning fluid barb 128 that protects outward from a first end of the central body 126 and is configured to be insertably positioned in the mating portion of the continuous tube 30. The thermal fluid conditioning barb 128 will be discussed in greater detail subsequently.

The central body portion 126 of the block assembly 44 can have any suitable configuration. In the embodiment depicted in the drawing figures, the central body portion 126 is composed of an elongated member that can be configured as a generally cylindrical element. The central body portion 126 defines a through shaft 130 that extends from a first end 132 to a second end 134. The first end 132 is configured with a suitable tube engaging surface that can engage the interior of the region of the outer tube shell 36 in a fluid tight manner. In the embodiment depicted in the drawing figures the tube engaging region proximate to the first end 132 of the central body portion 126 is configured with at least one barb 136. The at least one barb 136 can be pressed into an associated region of the outer tube shell 36 and sealed in a suitable manner. Non-limiting examples of suitable sealing means include either mechanical clamping means and/or adhesive means.

The though shaft 130 defined in the central body portion 126 is configured to define an internal passage through which the process fluid material as well as thermal conditioning fluid can both pass.

The block assembly 44 can also include at least one threaded or press-fit port region 138 located at the second end of the 134 of the central body portion 126 into which a liquid-tight fitting seal 140 can be installed. The liquid tight fitting seal 140 is configured with a central shaft 145 that can be oriented coaxial to the shaft 130 that is defined in the central body 126 when the device is in the use position. This configuration facilitates the passage of the thermal conditioning fluid into or out of the annular space formed between the outside diameter of the process fluid material conveying tube 34 and the inside diameter of the outer tube shell 36 disclosed herein.

In the embodiment depicted in FIGS. 4 and 5, the block assembly 44 also includes an externally threaded end 142 located proximate to the second end 134 of the central body portion 126 at an orientation opposite the at least one barb 136. The externally threaded end 142 also defines an internal region 144 having a concave taper 146 into which a compatibly tapered elastomeric seal 140 can be fitted and onto which a threaded cap 148 can be screwed to force the concave taper of the elastomeric seal 140 into the mating taper 146 in the internal region 144 in the end 134 of central body portion 126, compressing the central shaft 145 of the seal 140 from a first internal diameter that permits insertion of the process fluid material conveying tube 34 therein to a second smaller internal diameter to seal around the outside diameter of the process fluid material conveying tube 34.

The central body portion 126 also includes a side shaft 150 oriented perpendicular to the shaft 130 in fluid communication therewith. The side shaft is located in the central body portion 126 at a location between the first end 132 and the elastomeric seal 140. The side shaft 148 can be configured to engage a suitable thermal fluid conditioning barb 128 in fluid tight mating engagement with the central body 126. In the embodiment depicted in FIGS. 4 and 5, the side shaft 150 is configured with and internally oriented threaded surface 152 that can matingly engage a suitable outwardly threaded surface defined on the thermal fluid conditioning barb 128.

The thermal fluid conditioning barb 128 can be suitably configured to transfer suitable thermal conditioning fluid from an associated source to the device. The thermal conditioning barb 126 can include a suitable barb region 152 that is located distal to the outwardly threaded region (not shown) that matingly engages the side shaft 148. The thermal conditioning fluid barb also has a shaft 154 defined therein extending from the barb end to the opposed end. In the embodiment depicted in the drawing figures, the thermal conditioning barb 126 also is configured with a suitable elbow 156 that oriented the shaft in a suitable angle, such as a 90-degree angle in the drawing figures. The barb region 152 engages a suitable thermal conditioning fluid conveying conduit (not shown) to convey thermal conditioning fluid to or away from the device.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A fluid control module comprising:
at least one process fluid material conveying tube having an inlet end and an outlet end, an outwardly oriented surface and an inner channel, the process fluid material conveying tube having at least one coil region;
at least one outer tube shell coaxially disposed around the at least one process fluid material conveying tube and positioned a spaced distance therefrom, the at least one outer shell having an inlet end and an outlet end and an inwardly oriented surface, wherein the inwardly oriented surface of the outer shell and the outwardly oriented surface of the process conveying tube define a thermal conditioning fluid conveying channel; and
at least one viscosity sensor in fluid communication with the inner channel of the process fluid material conveying tube, the viscosity sensor being positioned in an area defined by the coil region defined in the process fluid material conveying tube, the viscosity sensor configured to generate data signals.

2. The fluid control module of claim 1 wherein the at least one coil region is characterized by spiral wraps of the process fluid conveying tube and the outer shell coaxially disposed thereto.

3. The fluid control module of claim 1 wherein the at least one viscosity sensor is in fluid communication with that inner channel of the process fluid conveying tube at a location proximate to the outlet end.

4. The fluid control module of claim 1 further comprising at least one pH sensor, the at least one pH sensor in fluid communication with the at least one process fluid material conveying tube, the at least one pH sensor configured to generate data signals.

5. The fluid control module of claim 1 wherein the at least one process material conveying tube is made of a rigid material.

6. The fluid control module of claim 5 wherein the at least one outer tube shell is composed of a flexible material.

7. The fluid control module claim 1 further comprising at least one end block assembly connected to one of the ends of the process fluid material conveying tube and the outer tube shell, the end block assembly having a central body and a central through channel, the end block assembly having an outer surface with at least one barb member extending outward therefrom, the end block assembly further having a threaded region defined on the outer surface at a location opposed to the barb, the threaded region configured to engage a compression cap.

8. The fluid control module of claim 1 further comprising a housing, the housing having opposed side wall panels, a top wall panel, a bottom support wall panel, a forward end wall panel and an opposed rearward end wall panel cooperatively defining an interior chamber, wherein the process fluid material conveying tube, the outer tube shell, and the at least one viscosity sensor are contained within the inner chamber defined in the housing, wherein the housing defines a thermally controlled environment,

9. The fluid control module of claim 8 wherein a thermal conditioning fluid inlet and a thermal conditioning fluid outlet are defined in the housing, the thermal conditioning fluid inlet and the thermal conditioning outlet in fluid communication with the respective inlet and outlet of the outer tube shell, and wherein a process fluid material inlet and process fluid material outlet are defined in the housing, the process fluid material inlet and the process fluid material outlet are in fluid communication with the respective process fluid material inlet and process fluid material outlet of the process fluid material tube.

10. The fluid control module of claim 9 wherein the housing further includes at least one sensor connection junction defined therein, the sensor connection junction in electronic communication with the at least one viscosity sensor, the viscosity sensor connection junction configured to convey electronic data to at least one location remote to the housing.

11. A fluid control module comprising:
at least one process fluid material conveying tube having an inlet end and an outlet end, an outwardly oriented surface and an inner channel, the process fluid material conveying tube having at least one coil region;
at least one outer tube shell coaxially disposed around the at least one process fluid material conveying tube and positioned a spaced distance therefrom, the at least one outer shell having an inlet end and an outlet end and an inwardly oriented surface, wherein the inwardly oriented surface of the outer shell and the outwardly oriented surface of the process conveying tube define a thermal conditioning fluid conveying channel;
at least one viscosity sensor in fluid communication with the inner channel of the process fluid material conveying tube, the viscosity sensor being positioned in an area defined by the coil region defined in the process fluid material conveying tube, wherein the at least one viscosity sensor is in fluid communication with that inner channel of the process fluid conveying tube at a location proximate to the outlet end of the process fluid conveying tube, the viscosity sensor configured to generate data signals; and
a housing, the housing defining a thermally isolated interior chamber, wherein the at least one process fluid material conveying tube, the at least one outer tube shell and the at least one viscosity sensor are contained in the thermally isolated interior chamber.

12. The fluid control module of claim 11 wherein the at least one coil region is characterized by spiral wraps of the process fluid conveying tube and the outer tube shell coaxially disposed thereto and wherein the area defined by the spiral wraps has a thermal region that surrounds at least a portion of the viscosity sensor.

13. The fluid control module of claim 12 further comprising at least one pH sensor, the at least one pH sensor in fluid communication with the at least one process fluid material conveying tube, the at least one pH sensor configured to generate data signals, wherein the at least one pH sensor is located in the isolated chamber defined in the housing at a location outside the thermal region defined by the spiral wraps defined in the process fluid conveying tube and the outer tube shell coaxially disposed thereto.

14. The fluid control module of claim 13 wherein the at least one process material conveying tube is made of a rigid material and the at least one outer tube shell is composed of a flexible material and wherein the spiral wraps are positioned a spaced distance from one another.

15. The fluid control module of claim 14 wherein a thermal conditioning fluid inlet and a thermal conditioning fluid outlet are defined in the housing, the thermal conditioning fluid inlet and the thermal conditioning outlet in fluid communication with the respective inlet and outlet of the outer tube shell, and wherein a process fluid material inlet and process fluid material outlet are defined in the housing, the process fluid material inlet and the process fluid material outlet are in fluid communication with the respective process fluid material inlet and process fluid material outlet of the process fluid material conveying tube.

16. The fluid control module claim 12 further comprising at least one end block assembly connected to one of the ends of the process fluid material conveying tube and the outer tube shell, the end block assembly having a central body and a central through channel, the end block assembly having an outer surface with at least one barb member extending outward therefrom, the end block assembly further having a threaded region defined on the outer surface at a location opposed to the barb, the threaded region configured to engage a compression cap.

17. The fluid control module of claim 16 wherein the at least one process fluid material conveying tube, the at least one outer tube shell coaxially disposed around the at least one process fluid material conveying tube and the at least one end block assembly connected to one of the ends of the process fluid material conveying tube and the outer tube shell form an assembly that is removable from the housing.

18. A fluid control module comprising:
at least one process fluid material conveying tube having an inlet end and an outlet end, an outwardly oriented surface and an inner channel, the process fluid material conveying tube having at least one coil region, the coil region;
at least one outer tube shell coaxially disposed around the at least one process fluid material conveying tube and positioned a spaced distance therefrom, the at least one outer shell having an inlet end and an outlet end and an inwardly oriented surface, wherein the inwardly oriented surface of the outer shell and the outwardly oriented surface of the process conveying tube define a thermal conditioning fluid conveying channel, characterized by spiral wraps of the process fluid conveying tube and the outer tube shell coaxially disposed thereto and wherein the area defined by the spiral wraps has a thermal region that surrounds at least a portion of the viscosity sensor;
at least one end block assembly connected to one of the ends of the process fluid material conveying tube and the outer tube shell, the end block assembly having a central body and a central through channel, the end block assembly having an outer surface with at least one barb member extending outward therefrom, the end block assembly further having a threaded region defined on the outer surface at a location opposed to the barb, the threaded region configured to engage a compression cap;
at least one viscosity sensor in fluid communication with the inner channel of the process fluid material conveying tube, the viscosity sensor being positioned in an area defined by the coil region defined in the process fluid material conveying tube, wherein the at least one viscosity sensor is in fluid communication with that inner channel of the process fluid conveying tube at a location proximate to the outlet end of the process fluid conveying tube, the viscosity sensor configured to generate data signals, wherein the at least one coil region is characterized by spiral wraps of the process fluid conveying tube and the outer tube shell coaxially disposed thereto and wherein the area defined by the spiral wraps has a thermal region that surrounds at least a portion of the viscosity sensor; and
housing, the housing defining a thermally isolated interior chamber, wherein the at least one process fluid material conveying tube, the at least one outer tube shell and the at least one viscosity sensor are contained in the thermally isolated interior chamber, wherein the at least one process fluid material conveying tube, the at least one outer tube shell coaxially disposed around the at least one process fluid material conveying tube and the at least one end block assembly connected to one of the ends of the process fluid material conveying tube and the outer tube shell form an assembly that is removable from the housing.

19. The fluid control module of claim 18 wherein the at least one process material conveying tube is made of a rigid material and the at least one outer tube shell is composed of a flexible material and wherein the spiral wraps are positioned a spaced distance from one another.

20. The fluid control module of claim 19 wherein a thermal conditioning fluid inlet and a thermal conditioning fluid outlet are defined in the housing, the thermal conditioning fluid inlet and the thermal conditioning outlet in fluid communication with the respective inlet and outlet of the outer tube shell, and wherein a process fluid material inlet and process fluid material outlet are defined in the housing, the process fluid material inlet and the process fluid material outlet are in fluid communication with the respective process fluid material inlet and process fluid material outlet of the process fluid material conveying tube.
